(19) United States
(12) Patent Application Publication
(10) Pub. No.: US 2020/0112193 A1
(43) Pub. Date: Apr. 9, 2020

(54) WIRELESS CHARGER SEAT FOR MOBILE DEVICE

(71) Applicant: Wei-Chieh Wu, Taichung (TW)

(72) Inventor: Wei-Chieh Wu, Taichung (TW)

(21) Appl. No.: 16/152,469

(22) Filed: Oct. 5, 2018

(51) Int. Cl. H02J 7/02; H02J 50/10; H02J 50/90; H04B 5/00

(52) U.S. Cl. CPC H02J 7/025; H04B 5/0037; H02J 50/90; H02J 50/10

(57) ABSTRACT

A wireless charging seat of a mobile device includes a seat body comprised of two integral and forwardly extended primary placing platforms and a floor end portion, a rear folding and clamping plate disposed at an end surface of an oblique end portion, a receiving and clamping space defined between the rear folding and clamping plate and a rear surface of the oblique end portion for clamping a charging coil, a clamping storage slot formed at an appropriate position of both sides of the rear folding and clamping plate separately for plugging and storing two auxiliary support members, corresponding plug slots formed on both sides of the bottom proximate to the oblique end portion, for selectively plugging the auxiliary support members to form an additional placing platform with a raised position.

### BACKGROUND OF THE INVENTION

### 1. Fields of the Invention

The present invention relates to a wireless charging seat of a mobile device, more particularly to the wireless charging seat applicable for general products of various brands and different sizes and having practical values and economic benefits.

### 2. Description of the Related Art

Various different mobile devices (such as mobile phones or a tablet PCs, etc.) have been developed with the latest wireless charging technology primarily using an inductive charging coil to perform an expected charging operation of a battery of the mobile devices. At present, the mobile devices of different brands or even different models usually have a specific and exclusive wireless charger for performing the aforementioned wireless charging operation.

Although this innovative charging technology provides convenience and better use to users, yet there is a problem as described below. As we all know, users have a high frequency of changing mobile device based on different reasons and the advancement of technology of the related industry also results in a frequent change of models and types of the related products. Now, almost everyone has a mobile phone, the users will eventually find that all kinds of wireless chargers stored in home may become useless after a period of time, which in turn creates a huge waste of resources and fails to comply with the requirements and regulations of the environmental protection which is of particular concern to the world today.

### SUMMARY OF THE INVENTION

An object of the invention is to provide a wireless charger using a single general-purpose wireless charger as a design prototype and including various models of charging coils of different brands, so that the users still can charge their mobile devices without the need of changing the wireless charger constantly. Obviously, the invention fully complies with the expected practical value and economic effects.

According to the invention, a wireless charging seat of a mobile device includes a seat body comprised of two integral and forwardly extended primary placing platforms and a floor end portion, a rear folding and clamping plate disposed at an end surface of an oblique end portion, a receiving and clamping space defined between the rear folding and clamping plate and a rear surface of the oblique end portion for clamping a charging coil, a clamping storage slot formed at an appropriate position of both sides of the rear folding and clamping plate separately for plugging and storing two auxiliary support members, corresponding plug slots formed on both sides of the bottom proximate to the oblique end portion, for selectively plugging the auxiliary support members to form an additional placing platform with a raised position.

### BRIEF DESCRIPTION OF THE DRAWINGS

The accomplishment of this and other objects of the invention will become apparent from the following description and its accompanying drawings of which:

FIG. 1 is an exploded view of the present invention;

FIG. 2 is a perspective view according to FIG. 1;

FIG. 3 is another perspective view according to FIG. 2;

FIG. 4 is a perspective view according to FIG. 2, showing that a charging coil is clamped;

FIG. 5 is a perspective view according to FIG. 4, showing that a mobile device is placed;

FIG. 6 is a side view according to FIG. 5;

FIG. 7 is a schematic view showing the status of additional placing platforms after two auxiliary support members are plugged into respective plug slots at an oblique end portion in accordance with the present invention;

FIG. 8 is a schematic view showing a using status of the present invention according to FIG. 7;

FIG. 9 is a schematic view of another embodiment of the present invention; and

FIG. 10 is schematic view showing a using status of the present invention according to FIG. 9.

### DETAILED DESCRIPTION OF THE PREFERRED EMBODIMENT

The present invention will now be described in more detail hereinafter with reference to the accompanying drawings that show various embodiments of the invention.

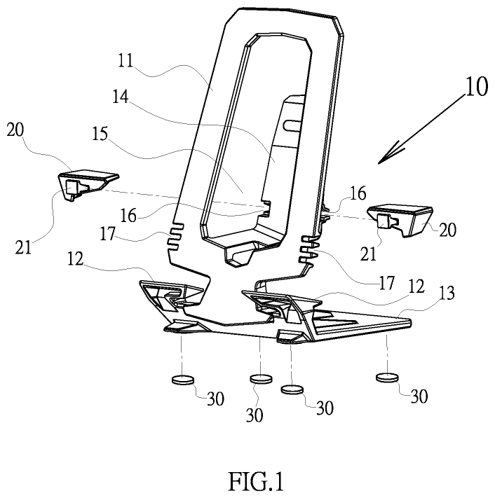

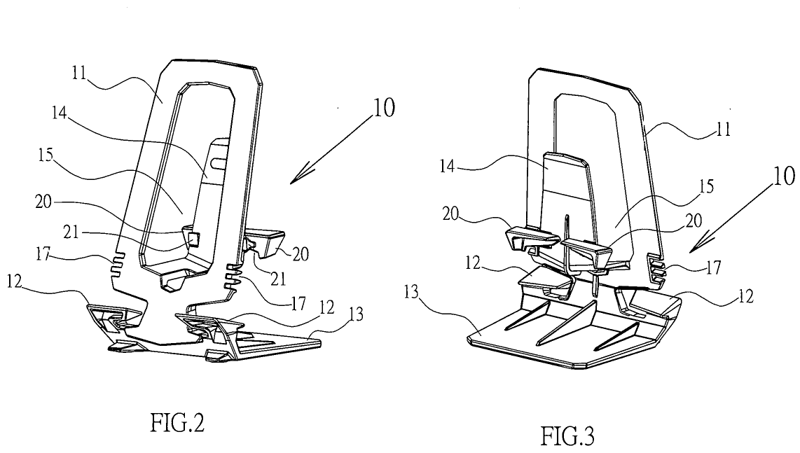

With reference to FIGS. 1, 2 and 3 for a wireless charging seat for a mobile device in accordance with the present invention, the wireless charging seat comprises: a seat body 10, comprised of two integral and forwardly extended primary placing platforms 12 and a floor end portion 13; a rear folding and clamping plate 14 disposed at an end surface of an oblique end portion 11, such that a receiving and clamping space 15 is defined between the rear folding and clamping plate 14 and a rear surface of the oblique end portion 11 for clamping a charging coil 40 stably; a clamping storage slot 16 formed at an appropriate position of both sides of the rear folding and clamping plate 14 separately for plugging and storing two auxiliary support members 20; a plurality of corresponding plug slots 17, formed on both sides of the bottom proximate to the oblique end portion 11 for selectively plugging the auxiliary support members 20 to form an additional placing platform 18 with a raised position; two auxiliary support members 20, with a top surface in a form of a platform, and having a latching bump 21 formed on a side of the auxiliary support member 20, and normally embedded into a corresponding clamping storage slot 16 of the rear folding and clamping plate 14 to define a stored status (at the positions as shown in FIGS. 2 and 3); and a plurality of floor pads 30, closely attached to an appropriate position of the bottom surface of the floor end portion 13.

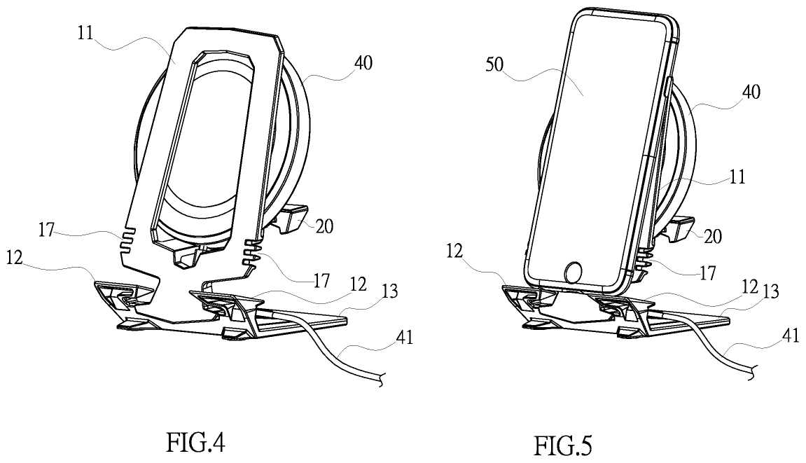

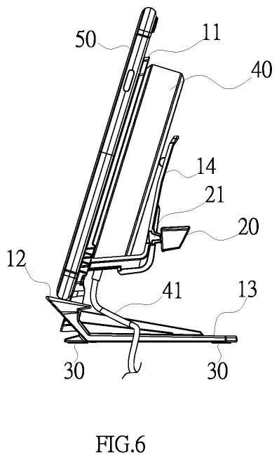

With the assembly of the aforementioned components, the charging coil 40 can be plugged from top to bottom into the receiving and clamping space 15 of the seat body 10 as shown in FIGS. 4, 5 and 6, and an elastic clamping force of the rear folding and clamping plate 14 forms a stable clamping status, and the mobile device 50 may be vertically set on the primary placing platform 12 in a stable manner, and the front surface of the oblique end portion forms and gives a support to the mobile device for an expected wireless charging operation.

Since the charging coil 40 and the mobile device 50 are known products, and the charging coil 40 requires a power cable 41 to be plugged to a power supply to convey electric power, therefore the charging coil 40 is inevitably a power supply circuit. The wireless charging technology and its principle are well-known art and not the technical characteristics of the present invention, and thus will not be described in details.

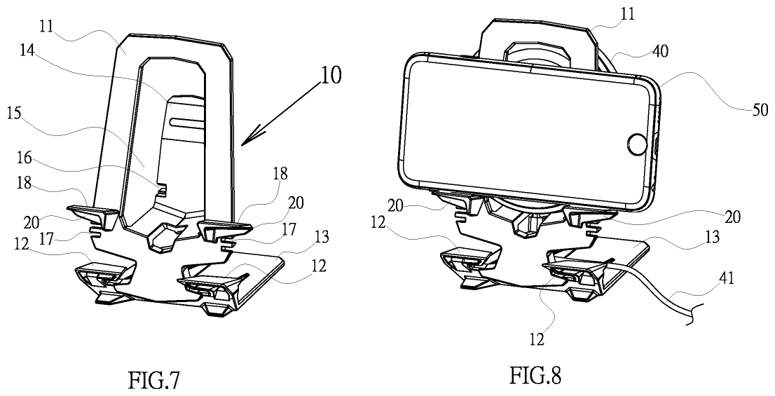

With reference to FIGS. 7 and 8 for a schematic view of a using status in accordance with another preferred embodiment of the present invention, if a user wants to set the mobile device 50 horizontally for charging, the user may remove the auxiliary support member 20 from the clamping storage slot 16 and then selectively plug the auxiliary support member 20 into any one plug slot 17 with a corresponding height by the effect of the latching bump 2 to form the additional placing platform 18 with a raised position, so as to meet the expected using requirement.

The selected installation height of the additional placing platform 18 is randomly determined and mainly depends on the width of the mobile device 50, so as to obtain the best charging position.

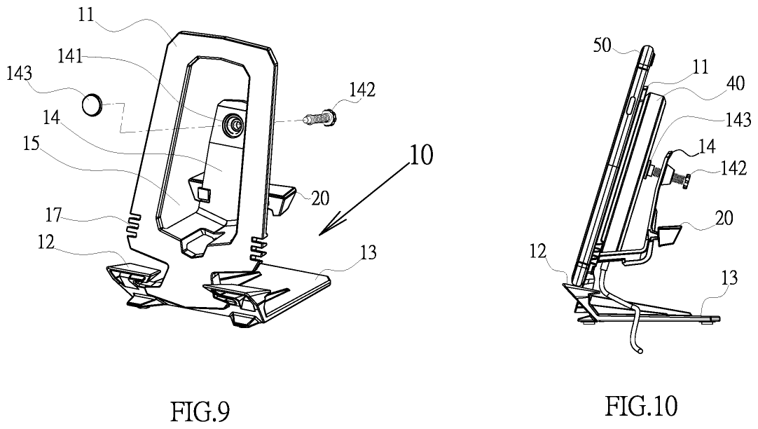

With reference to FIGS. 9 and 10 for another preferred embodiment of the present invention, the charging coil 40 further has a screw hole 141 formed at the top end of the rear folding and clamping plate 14 and a position adjusting screw 142 and a pad 143 configured to be corresponsive to the screw hole 141 and screwed into the screw hole 141 in order to adjust the position to abut the rear edge of the charging coil 40, and achieve the expected effect of clamping a mobile device with different thickness and sizes.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. A wireless charging seat of a mobile device, comprising:
a seat body, comprised of two integral and forwardly extended primary placing platforms and a floor end portion, wherein a rear folding and clamping plate is disposed at an end surface of an oblique end portion, such that a receiving and clamping space is defined between the rear folding and clamping plate and a rear surface of the oblique end portion, and a clamping storage slot is formed at an appropriate position of both sides of the rear folding and clamping plate separately for plugging and storing two auxiliary support members, and a plurality of corresponding plug slots are formed on both sides of the bottom proximate to the oblique end portion for selectively plugging the auxiliary support members to form an additional placing platform with a raised position;
two auxiliary support members, with a top surface in a form of a platform, and having a latching bump formed on a side of the auxiliary support member, and normally embedded into a corresponding clamping storage slot of the rear folding and clamping plate to define a stored status; and
a plurality of floor pads, closely attached to an appropriate position of the bottom surface of the floor end portion,
thereby, the charging coils are plugged from top to bottom into the receiving and clamping space, and an elastic clamping force of the rear folding and clamping plate forms a stable clamping status, and the mobile device is vertically or horizontally set on the primary placing platform or the additional placing platform in a stable manner, and the front surface of the oblique end portion forms and gives a support to the mobile device for an expected wireless charging operation.

2. A wireless charging seat of a mobile device, comprising:
a seat body, comprised of two integral and forwardly extended primary placing platforms and a floor end portion, wherein a rear folding and clamping plate is disposed at an end surface of an oblique end portion, and a receiving and clamping space is defined between the rear folding and clamping plate and a rear surface of the oblique end portion, while a screw is formed at the top end of the rear folding and clamping plate, and a clamping storage slot is formed at an appropriate position of both sides of the rear folding and clamping plate separately for plugging and storing two auxiliary support members, and a plurality of corresponding plug slots are formed on both sides of the bottom proximate to the oblique end portion for selectively plugging the auxiliary support members to form an additional placing platform with a raised position;
a position adjusting screw, configured to be corresponsive to a pad and screwed to a corresponding screw hole of the rear folding and clamping plate for adjusting and abutting the rear edge of the charging coil to provide a stable clamping effect;
two auxiliary support members, with a top surface in a form of a platform, and having a latching bump formed on a side of the auxiliary support member, and normally embedded into a corresponding clamping storage slot of the rear folding and clamping plate to define a stored status; and
a plurality of floor pads, closely attached to an appropriate position of the bottom surface of the floor end portion,
thereby, the charging coils are plugged from top to bottom into the receiving and clamping space, and clamped securely by the position adjusting screw, and the mobile device is vertically or horizontally set on the primary placing platform or the additional placing platform in a stable manner, and the front surface of the oblique end portion forms and gives a support to the mobile device for an expected wireless charging operation.
